(19) United States
(12) Patent Application Publication
(10) Pub. No.: US 2011/0114754 A1
(43) Pub. Date: May 19, 2011

(54) HYDROPOWER ROTATING OVERHEAD SHOWER

(75) Inventors: Renzhong LI, Xiamen (CN); Jianmin CHEN, Xiamen (CN); Wenxing CHEN, Xiamen (CN); Huasong ZHOU, Xiamen (CN)

(73) Assignees: Huasong ZHOU, Xiamen (CN); XIAMEN SOLEX HIGH-TECH INDUSTRIES CO., LTD., Xiamen (CN)

(21) Appl. No.: 12/620,792

(22) Filed: Nov. 18, 2009

(51) Int. Cl. B05B 3/02

(52) U.S. Cl. 239/222.11

(57) ABSTRACT

A hydropower rotating overhead shower, comprising a shower housing, an impeller rotating unit and a cover unit, wherein said impeller unit comprises an impeller cover and an impeller set in said impeller cover. The sidewall of said impeller cover has a water inlet and a sealing device for partially sealing said water inlet. The impeller is fastened with a mandrel, wherein the bottom of said mandrel is fastened with said cover unit, so said mandrel and cover unit can simultaneously rotate with said impeller. The shower has the following advantages: the sealing device is applied to partially seal the water inlet of the sidewall of the impeller cover so that the cover unit can be switched between rotatable and unrotatable. The shower generates either spray watering or ordinary flower watering, and it only needs one water channel for the water stream to flow out of the impeller cover.

### FIELD OF THE INVENTION

The present invention relates to a shower, especially relates to a hydropower rotating overhead shower.

### BACKGROUND OF THE INVENTION

In the modern society, bath is no more simply a way for cleaning the body dust, but also a important way of recreation and regimen, so the shower is not only used for flower watering, in order to meet different requirements of the users, the modern shower usually has many watering functions, such as massage watering, rotating watering, spray watering and so on, wherein each kind of watering function has a unique bath effect.

In the conventional technique of the rotatable shower, when the water stream strikes the impeller, the cover will rotate by the impeller, then a spiral rotating spray will be generated, the generation of said rotating spray needs an independent water channel, however, in order to meet the requirements of the users for an ordinary flower watering, it further needs to design an water channel of ordinary flower watering, so that at least two water channels are needed for the conventional rotatable shower, thus the shower structure will be complicated, and the cost is high, further it is inconvenient to switch the water channel. Moreover, the consumers also have different requirements of whether the cover is rotatable or not, but in the conventional shower, the cover can not be switched from rotatable to unrotatable, so it fails to satisfy the consumers.

### SUMMARY OF THE INVENTION

The main object of the present invention is to overcome the drawbacks of the conventional technique and provide a hydropower rotating overhead shower, its cover unit can either be rotatable or unrotatable by the control of the waterflow.

The technical solution applied by the present invention is:

A hydropower rotating overhead shower, comprising a shower housing, an impeller rotating unit and a cover unit, said impeller unit comprising an impeller cover and an impeller set in said impeller cover, the sidewall of said impeller cover has a water inlet, it further has a sealing device for partially sealing said water inlet; said impeller is fastened with a mandrel, the bottom of said mandrel is fastened with said cover unit, so said mandrel and cover unit can simultaneously rotate with said impeller.

Said sealing device comprising a sealing member and a knob, said sealing member is attached to the sidewall of said impeller cover, said knob is connected to said sealing member and drive said sealing member move for a certain distance for partially sealing the water inlet of the sidewall of said impeller cover.

The sealing area of said sealing member takes up at least 60% of the area of the water inlet of the impeller cover sidewall.

Said sealing member and knob is respectively disposed with a cam aperture and a cam post, and there are two restriction strips disposed by the two sides of the sidewall of said impeller cover wherein said sealing member is attached.

The water inlet disposed on the sidewall of said impeller cover is composed of a big water inlet and at least one small water inlet, after said sealing member has been moved for a certain distance by turning said knob, said big water inlet will be completely sealed

Said impeller rotating unit further comprising a supporting seat, said impeller cover is disposed on said supporting seat, and a supporting platform aperture is set on said supporting seat for making said knob rotate around its own axis.

Said impeller rotating unit further comprising a base seat which is set on said supporting seat.

Said mandrel has a water inlet and a water outlet, the water stream flows into the water inlet of said mandrel from the water inlet of the sidewall of said impeller cover, then flows into said cover unit from the water outlet of said mandrel, finally flows out of said cover unit.

The middle of said impeller has an irregular-shaped shaft aperture, the top of said mandrel has an irregular-shaped shaft, said impeller is fastened with said mandrel by the cooperation of said irregular-shaped shaft aperture and irregular shaft.

Said cover unit comprising a watering device, a TPR cover, a cover, a decoration inner cover and a decoration outer cover, said watering device is set on said TPR cover and said cover, said TPR cover is embedded on said cover, the outside of said cover is sleeved with said decoration inner cover, said decoration outer cover is set outside of said decoration inner cover.

The hydropower rotating overhead shower of the present invention, wherein the strike of the water column into the impeller cover is controlled by applying the sealing device to partially seal the water inlet on the sidewall of the impeller cover, because when the sealing device seals the water inlet, the strike direction of the water column is off-center unidirectional, then the impeller rotates under the strike of the water column and drive the cover unit rotate, too; when the sealing device does not seal the water inlet, the water column is off-center bidirectional, the opposing forces will cancel out, so the impeller keep still and the water stream can not drive the cover unit rotate, thus the cover unit can be controlled to switch from rotatble to unrotatable.

Concluded from the summary of the present invention and compared to the conventional technique, the hydropower rotating overhead shower of the present invention has such advantages: the present invention applies the sealing device to partially seal the water inlet of the sidewall of the impeller cover so that the cover unit can be switched rotatable or unrotatable, thus the present shower generates either spray watering or ordinary flower watering, and it only needs one water channel for the water stream to flow out of the impeller cover, the shower structure is simple and convenient to operate.

### BRIEF DESCRIPTION OF THE DRAWINGS

FIG. 1 illustrates the perspective view of the partial exploded structure of the detailed embodiment of the hydropower rotating overhead shower of the present invention.

FIG. 2 illustrates the perspective view of another partial exploded structure of the detailed embodiment of the hydropower rotating overhead shower of the present invention.

FIG. 3 illustrates the partial structure of the detailed embodiment of the hydropower rotating overhead shower of the present invention.

FIG. 4 illustrates the perspective view of the partial structure of the detailed embodiment of the hydropower rotating overhead shower of the present invention, wherein the big water inlet hasn't been sealed by the sealing member.

FIG. 5 illustrates the perspective view of the partial structure of the detailed embodiment of the hydropower rotating overhead shower of the present invention, wherein the big water inlet has been sealed by the sealing member.

FIG. 6 illustrates the perspective view of the impeller cover of the detailed embodiment of the hydropower rotating overhead shower of the present invention.

FIG. 7 illustrates the sectional view of the impeller cover of the detailed embodiment of the hydropower rotating overhead shower of the present invention.

FIG. 8 illustrates the perspective view of the sealing member of the detailed embodiment of the hydropower rotating overhead shower of the present invention.

FIG. 9 illustrates the perspective view of the knob of the detailed embodiment of the hydropower rotating overhead shower of the present invention.

FIG. 10 illustrates the perspective view of the impeller of the detailed embodiment of the hydropower rotating overhead shower of the present invention.

FIG. 11 illustrates the perspective view of the mandrel of the detailed embodiment of the hydropower rotating overhead shower of the present invention.

FIG. 12 illustrates the flowing direction of the water channel of the detailed embodiment of the hydropower rotating overhead shower of the present invention, wherein the big water inlet has been sealed by the sealing member.

FIG. 13 illustrates the flowing direction of the water channel of the detailed embodiment of the hydropower rotating overhead shower of the present invention, wherein the big water inlet hasn't been sealed by the sealing member.

FIG. 14 illustrates the striking of the water stream of the detailed embodiment of the hydropower rotating overhead shower of the present invention, wherein the big water inlet has been sealed by the sealing member.

FIG. 15 illustrates the striking of the water stream of the detailed embodiment of the hydropower rotating overhead shower of the present invention, wherein the big water inlet hasn't been sealed by the sealing member.

### DETAILED DESCRIPTION OF THE EMBODIMENTS

The present invention will become apparent upon the reference of the detailed embodiment.

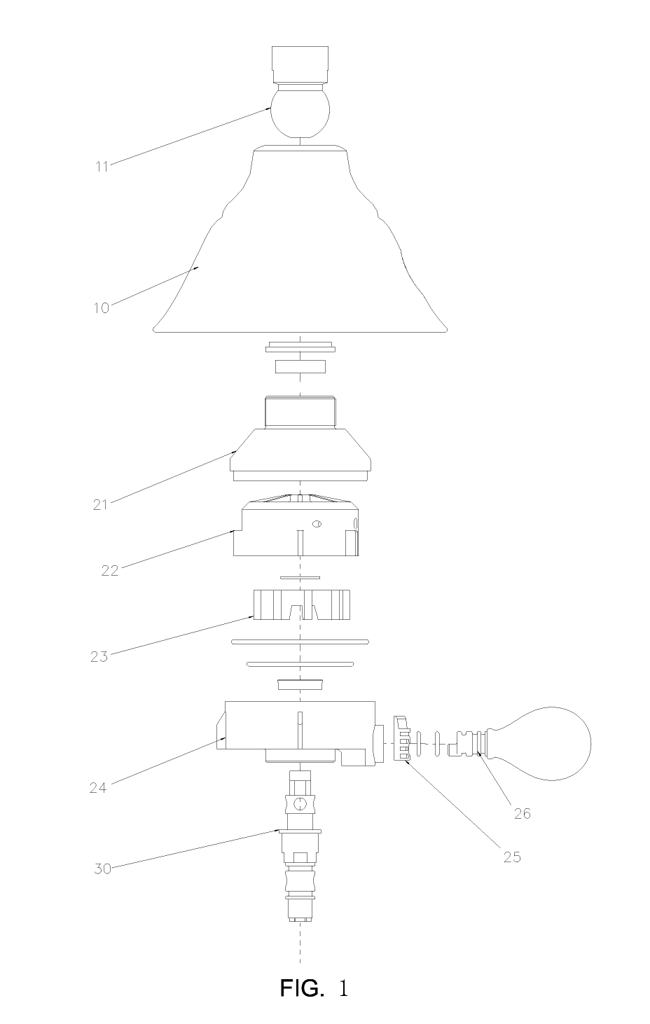

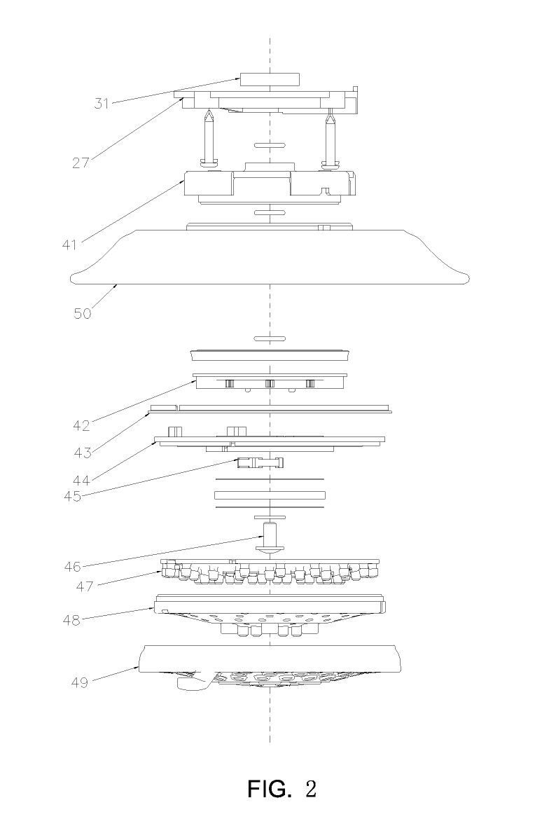

The hydropower rotating overhead shower of the present invention, please refer to FIG. 1 and FIG. 2, it comprising a housing 10, an impeller rotating unit, a mandrel 30 and a cover unit. The top of housing 10 comprises a ball head 11. Said impeller rotating unit comprising a top cover 21, an impeller cover 22, an impeller 23, a base seat 24, a supporting member 25, a knob 26 and a supporting base 27, the top of top cover 21 is connected to the ball head 11 and sleeved outside said impeller cover 22, the impeller 23 is set inside the impeller cover 22, said impeller cover 22 is set inside the base seat 24, said base seat 24 is set on the supporting seat 27, the knob 26 is supported on said supporting seat 27 and connected to the sealing member 25, said sealing member 25 is closely attached to the sidewall of the impeller cover 22. The mandrel 30 is sleeved with a deep groove ball bearing 31, while its top is fastened with the impeller 23. The cover unit comprising a rotating plate 41, a water division member 42, a friction ring 43, a watering member 44, a rotor 45, a screw 46, a TPR cover 47, a cover 48, a decoration inner cover 49 and a decoration outer cover 50, the above members cooperate with each other to form a watering channel, the whole cover unit is fixed on the bottom of the mandrel 30 by said screw 46.

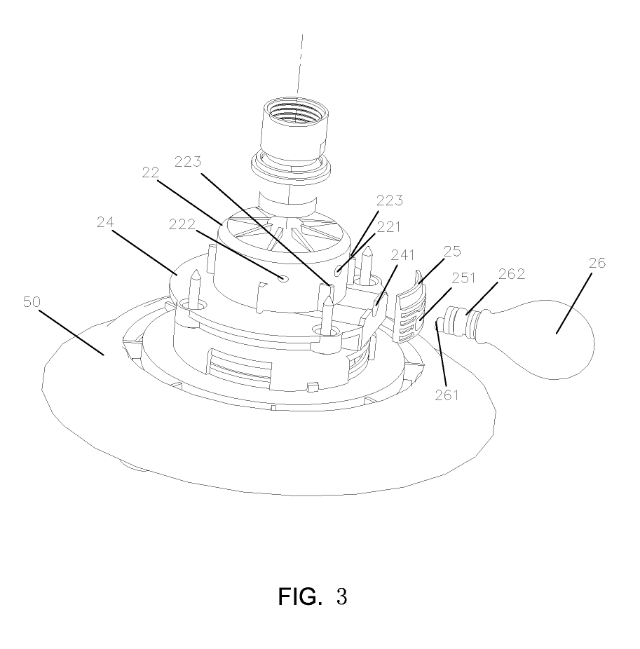

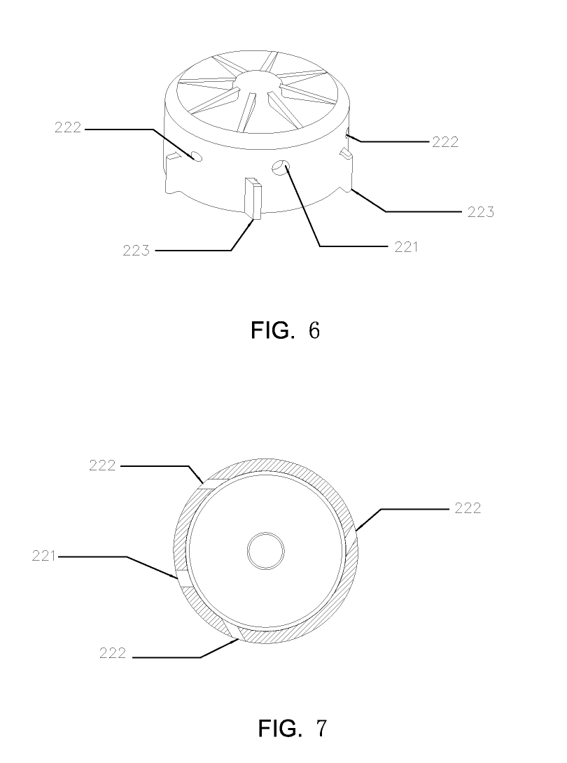

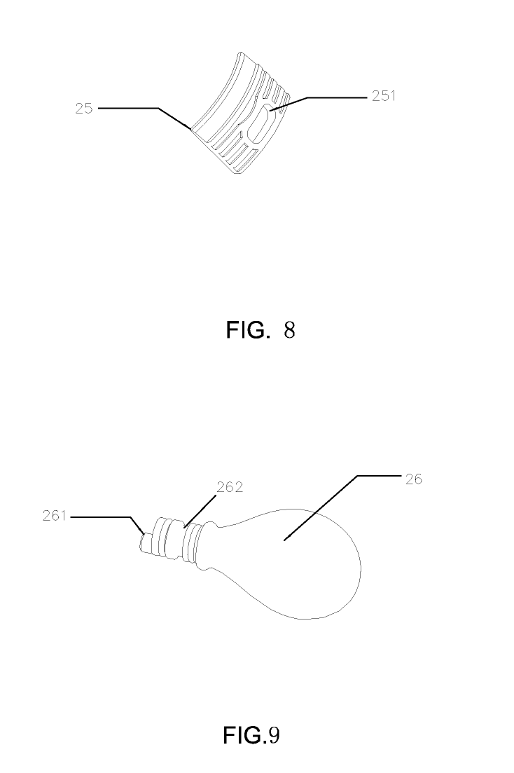

Please refer to FIG. 3, FIG. 6 and FIG. 7, the sidewall of said impeller cover 22 has a big water inlet 221 and three small water inlets 222, the area of the big water inlet takes up 70% of the area of all the four water inlets, there are two restriction strips 223 disposed by the two sides of the big water inlet 221. Please refer to FIG. 3, FIG. 8 and FIG. 9, the sealing member 25 is disposed with a cam aperture 251, a cam post 261 is correspondingly disposed on the knob 26, said knob 26 further has a depression part 262, by the supporting of said depression part 262 and knob 26 to the supporting platform aperture 271 of supporting seat 27, the knob 26 can rotate around its own axis. The sealing member 25 is restricted between the two restriction strips 223, so the sealing member can only move up and down.

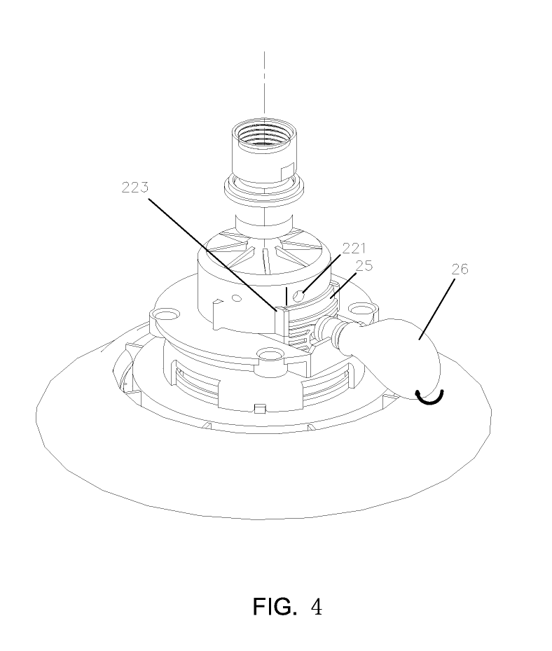

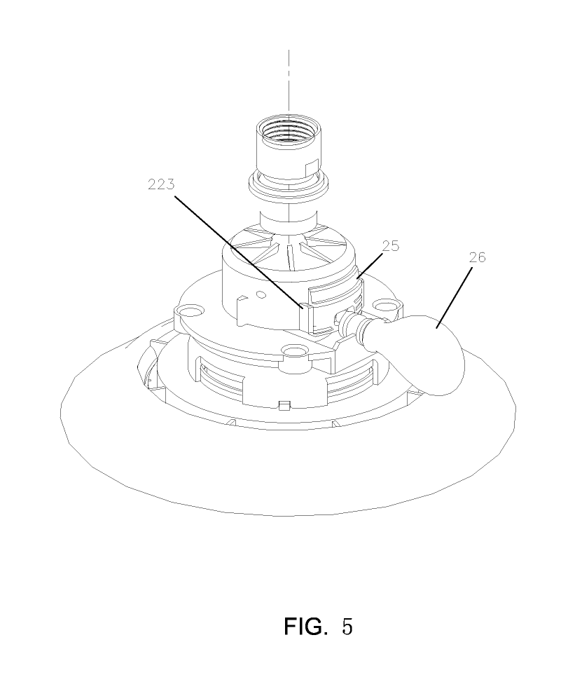

Please refer to FIG. 3, FIG. 4 and FIG. 5, when the knob 26 is turned in a clockwise direction, the knob 26 rotates clockwisely around its own axis by the supporting platform aperture 271, then the cam post 261 of knob 26 will be raised after rotating around a certain angle, because the cam post 261 leans against the top of the cam post 251 of the sealing member 25, so the sealing member 25 slides upwardly, and because of the restriction of the restriction strips 223 by the two sides of the sealing member 25, said sealing member 25 can only move upwardly, so the big water inlet 221 will be sealed; when turns the knob 26 in an anti-clockwise direction, the knob 26 rotates anti-clokwisely around it own axis by the supporting platform aperture 271, then the cam post 261 of knob 26 will be lowered after rotating around a certain angle, because the cam post 261 leans against the bottom of the cam aperture 251 of sealing member 25, so the sealing member 25 slides downwardly, and because of the restriction of the restriction strips 223 by the two sides of the sealing member 25, said sealing member 25 can only move downwardly, so the big water inlet 221 will be entirely exposed. Thus accomplish a cycle wherein the sealing member 25 moves up and down, that is the cycle of the big water inlet 221 has been sealed by the sealing member 25 or not.

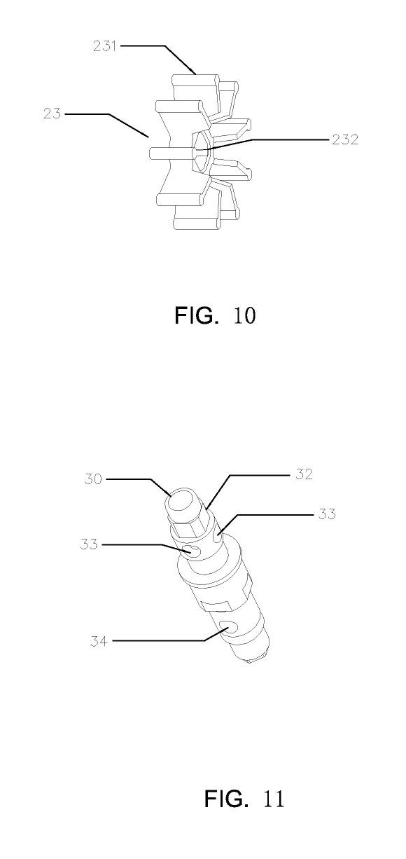

Please refer to FIG. 10 and FIG. 11, the impeller 23 comprising impeller blades 231 and irregular-shaped shaft aperture 232, the top of mandrel 30 is disposed with an irregular shaft 32, the impeller 23 is fastened with the mandrel 30 by the cooperation of the irregular shaft aperture 232 and irregular shaft 32; the mandrel 30 has a water inlet 33 and a water outlet 34, the water stream flows into the water inlet 33 of the mandrel 30 from the water inlet of the sidewall of the impeller cover 22, then flows to the cover units from the water outlet 34, finally flows out of the cover unit.

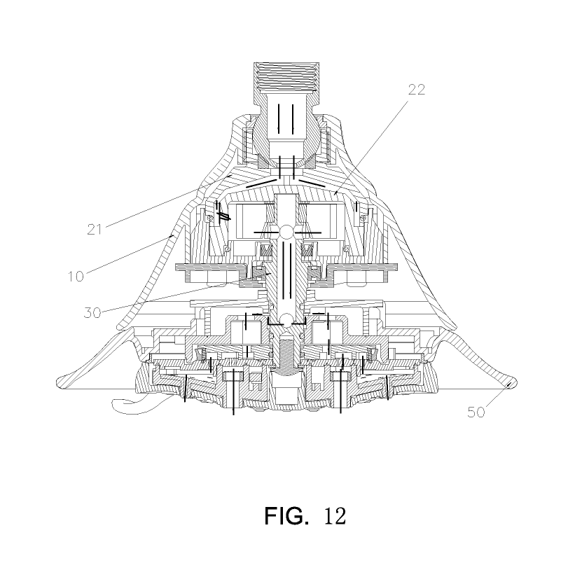

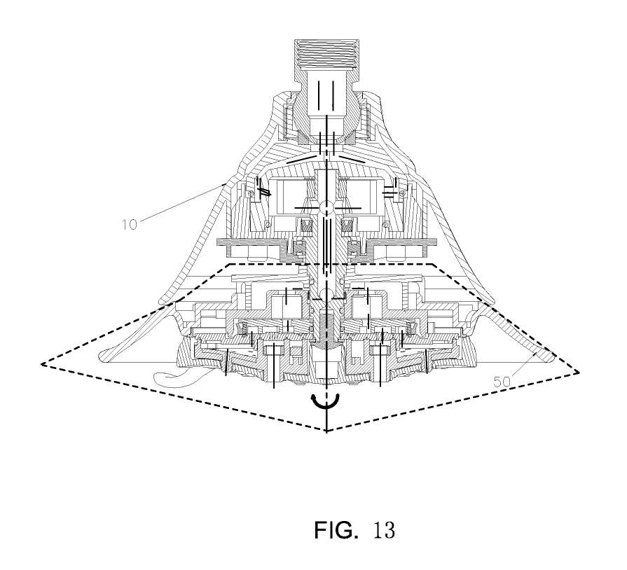

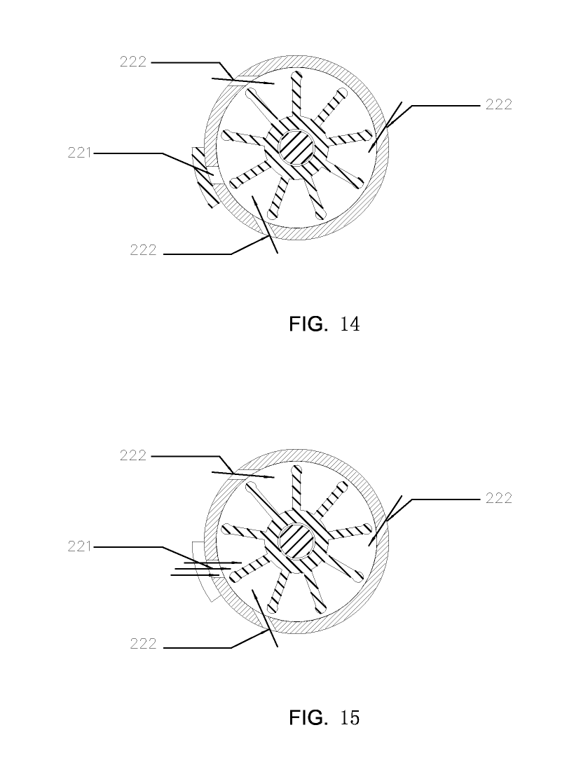

Please refer to FIG. 3, FIG. 4, FIG. 5, FIG. 12, FIG. 13, FIG. 14 and FIG. 15, when the knob 26 is turned clockwisely to drive the sealing member 25 move upwardly to seal the big water inlet 221, the water stream can only flows into the impeller cover 22 from the three small water inlets 222, the three water columns strike the impeller 23 in an off-center direction, then the impeller 23 is caused to rotate, because the cover unit is connected to the impeller 23 by the mandrel 30, so the cover unit is drove to rotate, then the water stream sprays rotably to form the rotatable spray watering.

Please refer to FIG. 3, FIG. 4, FIG. 5, FIG. 12, FIG. 13, FIG. 14 and FIG. 15, when the knob 26 is turned anti-clockwisely to drive the sealing member 25 move downwardly to unseal the big water inlet 221, then the water stream will flow into the impeller cover 22 from the three small water inlets 222 and big water inlet 221 simultaneously, the direction of water column sprayed from the three small water inlets 222 is opposite to the off-center of the water column of the big water inlet 221, so the torque on the impeller 23 from the striking of the two water columns are opposite and been cancelled out, then the impeller keep still. So the cover unit which is connected to the impeller 23 by the mandrel 30 can not rotate, at this moment, the shower of the present invention generates flower watering.

Please refer to FIG. 13, the cover unit is indicated within the dotted line, when the cover unit rotates, the present shower will not only generate spray watering, but also the bath experience will be more interesting.

Although the present invention has been fully explained by the detailed embodiment, the conventional parts such as sealing ring, isolating plate and isolating ring haven't been particularly explained, the hydropower rotating overhead shower of the present invention also contain these parts.

In the present invention, the position of the sealing member will be changed by turning the knob by hand, then the upward or downward for a certain distance of the sealing member can partially seal the water inlet, so the impeller can be switched from rotatable to unrotatable by increasing or reducing the vortex strength of the impeller cover, thus the cover unit can be switched rotatable or unrotatable.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

What is claimed is:

1. A hydropower rotating overhead shower, comprising a shower housing, an impeller rotating unit and a cover unit, wherein said impeller unit comprising an impeller cover and an impeller set in said impeller cover, the sidewall of said impeller cover has a water inlet, it further has a sealing device for partially sealing said water inlet; said impeller is fastened with a mandrel, the bottom of said mandrel is fastened with said cover unit, so said mandrel and cover unit can simultaneously rotate with said impeller.

2. The hydropower rotating overhead shower according to claim 1, wherein said sealing device comprising a sealing member and a knob, said sealing member is attached to the sidewall of said impeller cover, said knob is connected to said sealing member and drive said sealing member move for a certain distance for partially sealing the water inlet of the sidewall of said impeller cover.

3. The hydropower rotating overhead shower according to claim 2, wherein the sealing area of said sealing member takes up at least 60% of the area of the water inlet of the impeller cover sidewall.

4. The hydropower rotating overhead shower according to claim 2, wherein said sealing member and knob is respectively disposed with a cam aperture and a cam post, and there are two restriction strips disposed by the two sides of the sidewall of said impeller cover wherein said sealing member is attached.

5. The hydropower rotating overhead shower according to claim 2, wherein the water inlet disposed on the sidewall of said impeller cover is composed of a big water inlet and at least one small water inlet, after said sealing member has been moved for a certain distance by turning said knob, said big water inlet will be completely sealed.

6. The hydropower rotating overhead shower according to claim 2, wherein said impeller rotating unit further comprising a supporting seat, said impeller cover is disposed on said supporting seat, and a supporting platform aperture is set on said supporting seat for making said knob rotate around its own axis.

7. The hydropower rotating overhead shower according to claim 6, wherein said impeller rotating unit further comprising a base seat, said base seat is set on said supporting seat.

8. The hydropower rotating overhead shower according to claim 1, wherein said mandrel has a water inlet and a water outlet, the water stream flows into the water inlet of said mandrel from the water inlet of the sidewall of said impeller cover, then flows into said cover unit from the water outlet of said mandrel, finally flows out of said cover unit.

9. The hydropower rotating overhead shower according to claim 1, wherein the middle of said impeller has an irregular-shaped shaft aperture, the top of said mandrel has an irregular-shaped shaft, said impeller is fastened with said mandrel by the cooperation of said irregular-shaped shaft aperture and irregular shaft.

10. The hydropower rotating overhead shower according to claim 1, wherein said cover unit comprising a watering device, a TPR cover, a cover, a decoration inner cover and a decoration outer cover, said watering device is set on said TPR cover and said cover, said TPR cover is embedded on said cover, the outside of said cover is sleeved with said decoration inner cover, said decoration outer cover is set outside of said decoration inner cover.

11. The hydropower rotating overhead shower according to claim 3, wherein the water inlet disposed on the sidewall of said impeller cover is composed of a big water inlet and at least one small water inlet, after said sealing member has been moved for a certain distance by turning said knob, said big water inlet will be completely sealed.

12. The hydropower rotating overhead shower according to claim 4, wherein the water inlet disposed on the sidewall of said impeller cover is composed of a big water inlet and at least one small water inlet, after said sealing member has been moved for a certain distance by turning said knob, said big water inlet will be completely sealed.

13. The hydropower rotating overhead shower according to claim 3, wherein said impeller rotating unit further comprising a supporting seat, said impeller cover is disposed on said supporting seat, and a supporting platform aperture is set on said supporting seat for making said knob rotate around its own axis.

14. The hydropower rotating overhead shower according to claim 4, wherein said impeller rotating unit further comprising a supporting seat, said impeller cover is disposed on said supporting seat, and a supporting platform aperture is set on said supporting seat for making said knob rotate around its own axis.

15. The hydropower rotating overhead shower according to claim 13, wherein said impeller rotating unit further comprising a base seat, said base seat is set on said supporting seat.

16. The hydropower rotating overhead shower according to claim 14, wherein said impeller rotating unit further comprising a base seat, said base seat is set on said supporting seat.
